(19) United States
(12) Patent Application Publication
(10) Pub. No.: US 2025/0371474 A1
(43) Pub. Date: Dec. 4, 2025

(54) RESPONSIVE ASSESSMENT MODULE AND METHODS OF USE THEREOF

(71) Applicant: WhitworthKee Consulting, LLC, Washington, DC (US)

(72) Inventor: Chad Kee, Washington, DC (US)

(21) Appl. No.: 19/221,178

(22) Filed: May 28, 2025

Related U.S. Application Data
(60) Provisional application No. 63/652,406, filed on May 28, 2024.

(51) Int. Cl. G06Q 10/0637

(52) U.S. Cl. CPC G06Q 10/0637

(57) ABSTRACT

In some embodiments, the present disclosure provides an exemplary method that may include steps of identifying a plurality of data types associated with input data; determining a plurality of parameters corresponding to each data type of the plurality of data types; analyzing the plurality of parameters utilizing an enhanced survey module; dynamically generating a notification based on the analysis; and automatically executing the at least one recommendation via the enhanced survey module.

### FIELD OF TECHNOLOGY

The present disclosure generally relates to an advanced responsive assessment module and methods of use thereof.

### BACKGROUND OF TECHNOLOGY

Typically, an assessment model is a computer simulation framework that attempts to describe quantitatively, as much as possible, the cause-and-effect relationships of a specific issue and of the inter-linkages and interactions among different issues. An analytical model is quantitative in nature and used to answer a specific question or make a specific design decision. Different analytical models are used to address different aspects of the system, such as its performance, reliability, or mass properties.

### SUMMARY OF DESCRIBED SUBJECT MATTER

In some embodiments, the present disclosure provides an exemplary technically improved method that includes at least the following steps: identifying a plurality of data types associated with input data; determining a plurality of parameters associated with each data type of the plurality of data types; utilizing an assessment module to analyze the plurality of parameters associated with each data type, where the analysis of the plurality of parameters include a combination of a qualitative data analysis and a quantitative data analysis; dynamically generating a notification associated with an analysis of the plurality of parameters associated with each data type, where the notification comprises at least one recommendation for subsequent action based on the analysis; and automatically executing, by the at least one processor, the at least one recommendation via the assessment module.

### BRIEF DESCRIPTION OF DRAWINGS

Various embodiments of the present disclosure can be further understood with reference to the attached drawings, wherein like structures are referred to by like numerals throughout the several views.

FIG. 1 is a schematic block diagram illustrating the system architecture of a computing device integrated with an illustrative program engine for executing the responsive assessment module, in accordance with one or more embodiments of the present disclosure.

FIG. 2 is a schematic flow chart diagram depicting one embodiment of a method for utilizing a responsive assessment module to analyze input data and execute recommendations, in accordance with one or more embodiments of the present disclosure.

FIG. 3A is a bar graph summarizing survey responses related to equity perceptions across different organizational roles, in accordance with one or more embodiments of the present disclosure.

FIG. 3B depicts a bar graph illustrating satisfaction levels regarding inclusivity at KCC across different stakeholder groups, in accordance with one or more embodiments of the present disclosure.

FIG. 3C is a graph illustrating survey results on discrimination, harassment, and intimidation experiences across different stakeholder groups within a campus environment, in accordance with one or more embodiments of the present disclosure.

FIG. 4 is a schematic system diagram illustrating the interaction between client devices and network servers via a network, in accordance with one or more embodiments of the present disclosure.

FIG. 5 is a schematic block diagram illustrating the networked architecture of the responsive assessment module, including client devices, servers, databases, and cloud infrastructure, in accordance with one or more embodiments of the present disclosure.

FIG. 6 is a schematic block diagram illustrating the cloud-based architecture supporting the responsive assessment module, in accordance with one or more embodiments of the present disclosure.

FIG. 7 is a schematic block diagram illustrating the layered architecture of the system, including application, platform, and infrastructure components, in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a creator interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, daily, several days, weekly, monthly, etc.

As used herein, the term “runtime” corresponds to any behavior that is dynamically determined during an execution of a software application or at least a portion of software application.

The present disclosure describes, in detail, systems and methods of utilizing a responsive assessment module to automatically execute at least one recommendation associated with an analysis of a plurality of parameters for each data type within input data. The following embodiments provide technical solutions and technical improvements that overcome technical problems, drawbacks and/or deficiencies in the technical fields involving assessment analysis and recommendation generation. Such technical fields often operate within risk assessment, including building relations by developing a sense of community, collaborating and communicating for flexibility and efficiency, centering equity for systems change, incorporating culturally responsive practices, and valuing diverse voices. Specifically, a technological problem exists in merely relying on cultural-specific knowledge-based decisions to inform others of a difference of opinion, as this requires an individual to manually engage others and lacks a normalized quantification to deviations from historical norms. Typically, models generated with the goal of well-being of populations and strengthen outcomes of conducted research methods related to particular actions related to labor are inefficient, unreliable, and fail to utilize technology to ensure optimization of predictable results is obtained.

Over the last three decades, researchers have developed core concepts to community responsive assessment modules. These concepts highlight key areas of focus historically, theoretically, and practically. For example, in addition to having multiple trained evaluators, it was important that the evaluators acknowledge their internalized beliefs, biases and preferences as well as ensuring they center and understand the experiences of the community involved in the assessment. Some community responsive assessments challenge hegemonic forms of knowledge that oppress and/or subjugate communities ontologies and epistemologies. In the present disclosure, the responsive assessment module may dynamically leverage intersectional data to understand the multiple dimensions of people's lives as well as systemic impacts on equity, knowledge systems and interpersonal relationships that inform how organizations function. The dynamics within an assessment team (i.e., focus group discussion) and between the researchers and stakeholders are important because every member must have access to power and capital within the group to share perspectives, ask questions, and offer critique to ensure a credible exchange of information between groups, which can optimize an method to address organizational goals. In the present disclosure, the community responsive assessment module may include a broad, holistic vision of an organization and/or community to assess, including not just precise metrics, but expansive perspectives, history, lived experiences, and worldviews of it's stakeholders.

Identifying, through the assessment process, places where language, policies, procedures, and other aspects of institutional culture exclude people who may already be marginalized is an important step toward shifting organizations to be more inclusive. This is achieved in part by including the voices of all community members in the assessment process, with an acknowledgement that the organization can impact all members of the institution's community.

In some embodiments, the framework for conducting holistic assessments centered in culture may include the shared values, behaviors, customs, and beliefs of a particular group. In certain embodiments, the term “responsive” may refer to a process to attend to issues of culture and race in a meaningful way and informs assessment practices and procedures by centering the community throughout process within, and in response to, the culture of the organization or institution. The framework seeks to bring attention to historically marginalized groups by centering the community throughout the assessment process to capture their lived experiences and perceptions.

In the present disclosure, technical solutions and technical improvements herein include aspects of improved technologies for utilizing a responsive assessment module to dynamically generate a notification associated with an analysis of a plurality of parameters associated with each data type within input data and automatically executing the notification utilizing an enhanced survey module. The responsive assessment module may be configured in such a way as to combine artificial intelligence generated predicted activity recommendations to recommend modifications to activities associated with an individual. The responsive assessment module may dynamically communicate with a trained machine learning module, a natural language processing module, an enhanced survey module, and an input interface to optimize the generation of the recommendations and the execution of actions associated with the recommendations. Accordingly, the responsive assessment module provides analysis of the plurality parameters associated with the input data, including outputs from the one or more machine learning statistical and/or algorithmic models. Based on such technical features, further technical benefits become available to users and operators of these systems and methods. Moreover, various practical applications of the disclosed technology are also described, which provide further practical benefits to users and operators that are also new and useful improvements in the art.

In certain embodiments, a plurality of assessments conducted via the responsive assessment module may be important tools for understanding organizations, strategic planning and organizational progress and goal attainment. There are several types of assessments associated with the responsive assessment module which include formative assessments, summative assessment, process assessments, outcomes assessments, and impact assessments. In some embodiments, the use of each particular assessment varies on the goals, needs and historical context of the organization. For example, formative assessments usually occur with organizations in their infancy as they refine a particular program. While summative assessments help to determine whether to continue, terminate or broaden an organization or a particular intervention. In some embodiments, the plurality of assessments are also important tools to ensure efficient and effective processes, to assess the impact of a particular program or intervention or to influence broader policy and catalyze change.

In some embodiments, the plurality of assessments may refer to the act of appraising the level of performance in a particular area. As it pertains to campus culture and climate, assessment asks the questions. In certain embodiments, the plurality of assessments may focus more on goals and the degree to which specific, predetermined goals are being met. In certain embodiments, the responsive assessment module is an optimization assessment tool.

There are several important elements that contribute to meaningful assessments including history, power, reflexivity which must leverage intersectional analytics to be culturally responsive and advance justice, equity, diversity and inclusion in organizations. Intersectionality is a theoretical and analytical framework that is an analytic framework that is interested in structures of power and interlocking axes of domination. In certain embodiments, intersectionality looks at the co-constituted structures of racism, sexism, classism, heterogenderism, ableism and beyond; the responsive assessment module analyzes how systems of power impact individuals differently based on their identities or how their identities are perceived by society.

### Guiding Principles of the Responsive Assessment Module

The principles associated with the exemplary responsive assessment module may include history, location, power, voice, relationship, time, return, plasticity, and reflexivity. In some embodiments, history is an element that solicits the story of the organization including key events and the organization's experiences with assessments. The second element, location, examines cultural contexts, values, meaning making and connections to land. The third element, power, examines privilege, prejudice, equity, social justice, discrimination and disparity. It also looks at both formal and informal sources of power and who holds power within the organization. The fourth element is connection. It is important to center respect and responsibility to support connection within the organization and how the organization relates to the evaluators. The fifth element is voice, which examines who participates in decision making and maps inclusion and marginalization. The sixth element is time and examines the pace of the plurality of assessments and implementation to account for short- and long-term consequences. The seventh element is return which seeks to ensure the results of each assessment add value to the organization and/or any plurality of experiences associated with each individual within the organization. The eighth element is plasticity, and it focuses on malleability on the part of the researchers and the organization, ensuring that each assessment is responsive to shifting local contexts and new understandings. The last element is reflexivity; reflexivity is an iterative process that examine the strengths and limitations of each assessment, the researchers' preconceived notions and examine the validity of counterarguments.

At its core, the exemplary responsive assessment module is an assessment model that centers culture and, as such, it is built around valuing, respecting, and cultivating relationships and community. Historically, research examining the culture, traditions, beliefs, and behaviors of marginalized groups has led to “othering,” when members of a research team come from the “outside” with a desire to learn about a specific group or culture. This has led to a lot of mistrust between certain marginalized groups and researchers from the dominant culture.

Members of research teams associated with the responsive assessment module have a strong desire to understand the goals and values of the community and to include members of all representative affinity groups, not just dominant perspectives. In order to do so effectively, researchers must be thoughtful and intentional about building trust with members of the community of interest to learn how power flows through the organization.

In some embodiments, the assessment team must take time and care to prepare themselves and the community for the assessment. These dynamics aid the assessment team in organizing appropriate focus groups in an effort to create a space in which members of the community feel comfortable to speak candidly about their lived experiences.

Communication is a key component of developing collaborative relationships between assessment teams and organizations. It is of vital importance to ensure early and ongoing effective communication to communicate openness, flexibility, respect as well as efficiency. These values can be communicated early in the assessment relationship by creating regular standing meetings with key stakeholders where everyone is encouraged to speak, ask questions, and share anecdotes and norms. It is important that there is emphasis on active listening and communication in early phases like the environmental scan and throughout the assessment that are facilitated by a culture of openness, where this active listening and communication can produce a greater sense of trust throughout the assessment yielding richer data.

Engaging stakeholders early in the process and building trust facilitates communication and ease of collaboration. Forming strong working relationships within the community communicates respect and that the evaluators respect the community members' time, making an effort to make the assessment process as efficient as possible. Engaging the community in a collaborative role in the process associated with the exemplary responsive assessment module honors the need to be flexible and respectful of the needs of the community and assists in consistently centering culture by soliciting guidance from the plurality of individuals within the organization.

Equity is a concept that describes intersectional fairness, which differs from equality. While equality means giving everyone equal treatment, equity requires looking at the individual and community level through a historical and cultural perspective to understand their unique needs and level the playing field. Equity requires an engagement with multiple histories, a continuous interrogation of power as well as reflexivity on the part of both the researcher and the organization being evaluated.

In each assessment, it is important to consider that people do not live “single-issue” lives. Rather, people represent a conglomerate of identities, cultures and relationships to power. For example, when examining issues in racialized communities, it is imperative that evaluators also consider issues of class, gender, disability, sexuality, nation of origin, immigration status, geographic setting and more to ensure systems of power are represented fairly and accurately. When researchers consider the impacts of intersecting axes of domination, a complex snapshot emerges that can be met with complex solutions and interventions to meet the needs of those most marginalized. For example, if researchers are assessing a program that serves black students at an academic institution, it is important to ensure that black queer, transgender, disabled, international, scholarship recipients, student leaders, federal work study recipients, greek letter organization members, legacy students, first generation student, residential students, commuter students, as well as black students from various disciplines and more, are included to understand the nuances, contours and dimensions that make up the experience of this diverse communities. However, it becomes increasingly important to retain anonymity of participant identities when presenting findings from groups and sub-groups.

Centering equity is a call that requires evaluators to leverage intersectional analytics to ensure that researchers work from the margins to the center as they assess and intervene within organizations. Centering equity requires evaluators to investigate beyond the surface to initiate systems changes that yield better outcomes, especially to those experiencing multiple levels of marginalization, who can often be obscured by single axis analyses. In order to center equity, there needs to be iterative analysis that involves deep reflexivity on the part of the organization as well as the researchers. As design environmental scans, an enhanced survey tool may ensure that intersectionality is centered. In some embodiments, the exemplary responsive assessment module may communicate the importance of an intersectional lens and analytic to organizations to ensure they are aware and equipped to address numerous, complex and even contradictory feedback shared by members of their organization.

In certain embodiments, the term responsiveness may refer to an intentional act of implementing a client-centered approach to the assessment, taking into account the culture and culturally specific needs of the organization or institution being assessed. When research consultants, engaged in culture and climate assessments choose to be culturally responsive, they structure the research activities in a way that may be intentionally inclusive. For example, researchers may create a forum for open discussions to understand the cultural diversity represented across institutions, encourage clients to review data collection materials, and share information in a manner that is accessible regardless of level of education.

In certain embodiments, the term culture may refer to a totality of the plurality of assessments to consider all forms of diversity and identities and a position that may be reflected within the community. In some embodiments, the exemplary responsive assessment module may be centered throughout the process, which leads to more effective use of results of the assessment as respondents are consistently included throughout each step of the design.

In certain embodiments, the exemplary responsive assessment module may go beyond merely considering culture as an aspect or layer of assessment. Instead, a cultural context may be embedded in every aspect of the process. The exemplary responsive assessment module may be designed to intentionally engage the community who will participate in the focus groups and complete the survey, allowing their voices to be present at every stage of the process. In some embodiments, the researchers associated with the responsive assessment module may seek to understand the community through an environmental scan and landscape analysis before designing the assessment to ensure cultural needs are thoughtfully included in the assessment process.

Recognizing that a meaningful and useful assessment must be comprehensive and reflective of the culture of the organization, the exemplary responsive assessment module prioritizes the equitable involvement of all voices (race, gender, class, religious beliefs, age, disability, language acquisition, immigration status, etc.). Involvement of individuals from diverse backgrounds occurs throughout the entire assessment process to ensure that each assessment of the plurality of assessments approach fully addresses key questions from multiple perspectives. Within the exemplary responsive assessment module, researchers may attend to multiple identities in the analysis to ensure hidden inequities and nuances that may be part of unique social identities are exposed. For example, black male students may have different outcomes from those of black female students and their black transgender or intersex student peers, which are not apparent when intersectional identities are not considered. It is important to include emerging identities into popular discourse to ensure minority voices are not obscured. For example, when examining gender, it's of critical importance to include genders beyond the traditional sex binary because many groups experience gender oppression that's overlooked because of the focus on men and women. Including and valuing diverse voices include thinking expansively and dynamically about the nature of identity as it relates to systemic oppression.

During an assessment of the plurality of assessments, there may be instances of low response rates or sample sizes. There may be a low representation of marginalized groups. This may be related to the level of trust members of the community have with the research team, which is why the responsive assessment module may prioritize matching research team members to members of the community who share some identities in common. A researcher who identifies as female may lead a focus group with female community members. In addition, there may be personal and emotional reasons that prohibit engagement from marginalized populations. Individuals from marginalized groups may feel threatened or uncomfortable, for example, when asked to share their impressions of the institution in front of members of another group, especially if those others are in positions of power.

Despite low response rates, to be inclusive and incorporate multiple voices, the exemplary responsive assessment module may equally value and include their perspective of each researcher and proactively seek a wide representation for the research phase (focus groups and survey administration) to mitigate some of these challenges.

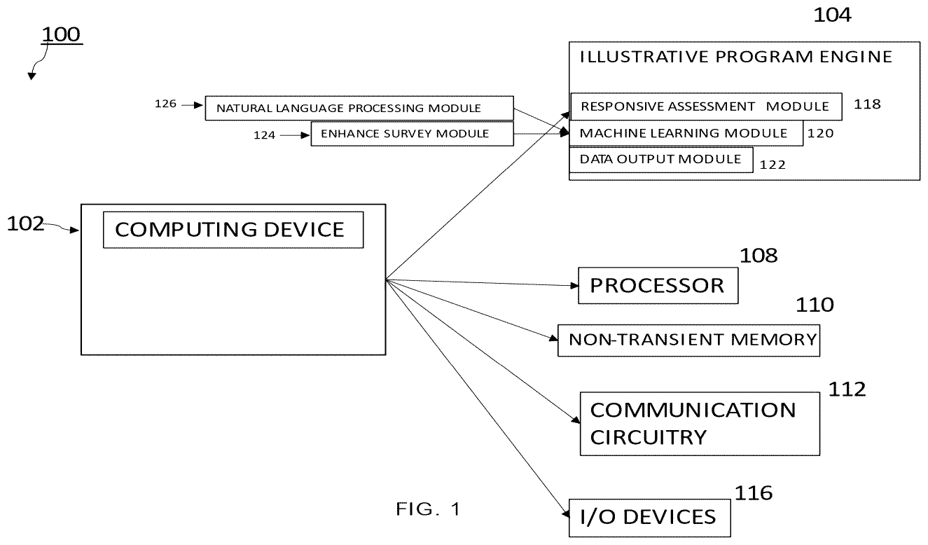

FIG. 1 depicts a block diagram of an exemplary computer-based system and platform for automatically modifying the interaction session to orchestrate a transfer of at least one artifact of the set of artifacts between at least two entities, in accordance with one or more embodiments of the present disclosure.

In some embodiments, an illustrative computing system 100 of the present disclosure may include a computing device 102 associated with at least one user and an illustrative program engine 104. In some embodiments, the illustrative program engine 104 may be stored on the computing device 102. In some embodiments, the illustrative program engine 104 may be stored on the computing device 102, which may include a processor 108, a non-transitory memory 110, a communication circuitry 112 for communicating over a communication network 114 (not shown), and input and/or output (I/O) devices 116 such as a keyboard, mouse, a touchscreen, and/or a display, for example. In some embodiments, the computing device 102 may refer to at least one communication-enabled computing device of a plurality of communication-enabled computing devices.

In some embodiments, the illustrative program engine 104 may be configured to instruct the processor 108 to execute one or more software modules such as, without limitation, an exemplary responsive assessment module 118, a machine learning module 120, and/or a data output module 122.

In some embodiments, the exemplary responsive assessment module 118 of the present disclosure, may utilize at least one machine learning algorithm, described herein, to identify a plurality of data types associated with input data. In certain embodiments, the input data may refer to a collection of historical data associated with output of a plurality of action-specific focus group discussions, where each focus group discussion refers to a plurality of questions and a plurality of answers to provide information associated with a prediction of an outcome associated with a recommendation based on the output of the plurality of action-specific focus group discussion. In certain embodiments, each data type of the plurality of data types may coordinate with each type of focus group discussion. For example, a focus group discussion may refer to actionable items of construction and labor advancements, executive advancement, infrastructure improvement and financial optimization within a predetermined location. In some embodiments, the exemplary responsive assessment module 118 may determine a plurality of parameters associated with each data type of the plurality of data types. In certain embodiments, the plurality of parameters may refer to a collection of outputs of calculated predictions associated with each data type of the plurality of data types. In some embodiments, the exemplary responsive assessment module 118 may utilize an enhanced survey module 124 to analyze the plurality of parameters associated with each data type. In certain embodiments, the analysis of the plurality of parameters may refer to a combination of qualitative data analysis results and quantitative data analysis results. In some embodiments, the exemplary responsive assessment module 118 may dynamically generate a notification associated with the analysis of the plurality of parameters associated with each data type. In certain embodiments, the notification may refer to at least one recommendation for subsequent action related to the input data based on the analysis of the plurality of parameters. In some embodiments, the exemplary responsive assessment module 118 may automatically execute the at least one recommendation via the enhanced survey module 124. In certain embodiments, the at least one recommendation may refer to an executable action capable of optimizing a performance of a system based on output of the analysis of the plurality of parameters for each data type of the input data.

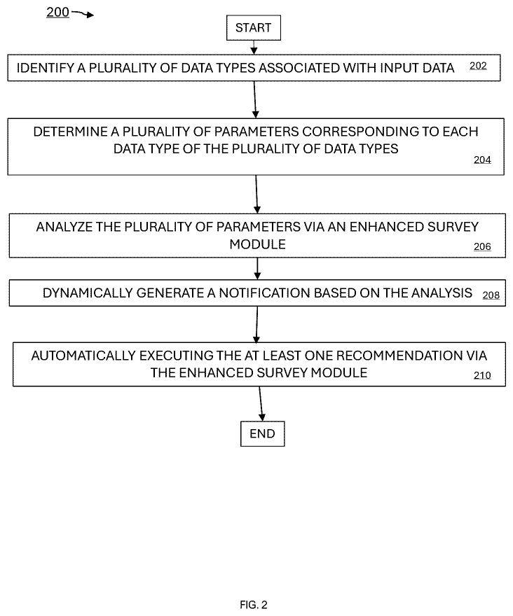

FIG. 2 is a flowchart 200 illustrating operational steps for automatically modifying the interaction session to orchestrate a transfer of at least one artifact of the set of artifacts between the at least two entities, in accordance with one or more embodiments of the present disclosure.

In step 202, the illustrative program engine 104 of the computing device 102 identifies a plurality of data types associated with input data. In certain embodiments, the input data may refer to a collection of historical data associated with output of a plurality of action-specific focus group discussions, where each focus group discussion refers to a plurality of questions and a plurality of answers to provide information associated with a prediction of an outcome associated with a recommendation based on the output of the plurality of action-specific focus group discussion. In certain embodiments, each data type of the plurality of data types may coordinate with each type of focus group discussion. For example, a focus group discussion may refer to actionable items of construction and labor advancements, executive advancement, infrastructure improvement and financial optimization within a predetermined location. In some embodiments, the exemplary responsive assessment module 118 may identify the plurality of data types associated with the input data.

In step 204, the illustrative program engine 104 determines a plurality of parameters associated with each data type of the plurality of data types. In certain embodiments, the plurality of parameters may refer to a collection of outputs of calculated predictions associated with each data type of the plurality of data types. In certain embodiments, the illustrative program engine 104 may utilize a trained machine learning module 120 to determine the plurality of parameters associated each data type, and whether each parameter is present within the input data. In some embodiments, the exemplary responsive assessment module 118 may utilize the trained machine learning module 120 to determine the plurality of parameters associated each data type.

In step 206, the illustrative program engine 104 analyzes the plurality of parameters. In some embodiments, the illustrative program engine 104 may analyze the plurality of parameters associated with each data type. In some embodiments, the illustrative program engine 104 may utilize the enhanced survey module 124 to analyze the plurality of parameters associated with each data type. In certain embodiments, the analysis of the plurality of parameters may refer to a combination of qualitative data analysis results and quantitative data analysis results. In some embodiments, the exemplary responsive assessment module 118 may utilize the enhanced survey module 124 to analyze the plurality of parameters associated with each data type.

In step 208, the illustrative program engine 104 dynamically generates a notification. In some embodiments, the illustrative program engine 104 may dynamically generate at least one notification associated with the analysis of the plurality of parameters associated with each data type. In certain embodiments, the notification may refer to at least one recommendation for subsequent action related to the input data based on the analysis of the plurality of parameters. In some embodiments, the illustrative program engine 104 may utilize a natural language processing module 126 to generate the at least one notification associated with the analysis of the plurality of parameters. In some embodiments, the exemplary responsive assessment module 118 may utilize the natural language processing module 126 to generate the at least one notification associated with the analysis of the plurality of parameters.

In step 210, the illustrative program engine 104 automatically executes at least one recommendation. In some embodiments, the illustrative program engine 104 may automatically execute the at least one recommendation via the enhanced survey module 124. In certain embodiments, the at least one recommendation may refer to an executable action capable of optimizing a performance of a system based on output of the analysis of the plurality of parameters for each data type of the input data. In some embodiments, the exemplary responsive assessment module 118 may automatically execute the at least one recommendation via the enhanced survey module 124.

In certain embodiments, the exemplary responsive assessment module 118 activities may be organized into at least five phases. These phases were developed and informed by the principles outlined in the framework with the intention of incorporating culturally responsive practices into a formal assessment process, resulting in concrete recommendations for actionable change. The five phases of the exemplary responsive assessment module 118 are: campus culture and organizational climate assessments should be conducted by an outside consulting agency or research firm, to ensure the process is objective. Ideally the consultants have expertise in power, privilege, oppression and cultural responsiveness.

The assessment process may be initiated with a formal kick-off meeting to outline and discuss the assessment activities, establish and explain deliverables, and to establish a formal method of working together. The goal of this meeting is to identify the purpose of the assessment and what the community desires out of the process. Members in attendance at this meeting are the consultants and/or research team members, institutional leaders and any other key decision-makers.

During the kickoff meeting, the consultants focus on gathering information from the institution's leadership team about the intentions guiding their request for an equity audit or assessment, what their goals and visions are for the assessment, including how they plan to use the information gathered by the consultants, and what may need to be customized for this client and how. For example, a Native and Indigenous Serving Institution may wish to include community elders in the process. As consultants, it is important to ensure that the unique contours of each community are visible, valued and incorporated throughout the assessment. The customizations ensure that each community's goals and histories shape the assessment and inform the consultant's recommendations.

In certain embodiments, the research team provides some background about the exemplary responsive assessment module 118 approach to the assessment process. This may provide information on the equity assessment process and seek to learn more about the institution, the points of contact and the leadership and address any questions about the equity assessment. In some embodiments, the consultant team also conducts informal discussions with institutional stakeholders to gain an understanding of what is working and not working at the institution, especially with regard to diversity, equity, and inclusion. The information gathered from the meeting will inform the process and measures used in the equity assessment.

The purpose of the environmental scan (sometimes referred to as a “landscape analysis”) may be to gain a deeper understanding of the organization's history, leadership and determine the types of initiatives currently in place to understand the perceptions and lived-experiences of the community within that organization. The environmental scan includes a review of existing data, such as demographic data, mission and vision statement, organizational chart, strategic plan, and institutional policies and procedures. The team may review additional documents including the organizational catalog, the mission and vision statement, organizational charts, any existing reports related to the advancement of executable actions within the organization, and/or the institution's website.

During the environmental scan phase of the process, the research team may also conduct informal meetings that will help to establish open and trusting relationships, leading to honest, authentic discussions about executable actions. These relationships also result in more buy-in from various stakeholders, ultimately facilitating higher survey response rates and engagement. The intention behind the environmental scan is to identify the motivations and needs of the assessment, conduct a rapid assessment of the existing climate, and define the purpose of the assessment and specific areas of focus.

The intended outcome of the environmental scan is the establishment of trust between the research team and members of the community, the establishment of clear expectations, especially with leadership, and identification of key issues related to executable actions. Information from these meetings inform the entirety of the assessment including the focus group structure in the next step of the process.

As part of the equity assessment, the consultant team facilitates a predetermined number of focus group sessions with stakeholders. The focus group sessions are qualitative data collection opportunities used to inform the development of a survey to better understand the current institutional social environment.

Members of the assessment team conduct focus groups with community members who can provide perspectives on the institutional climate. Each focus group typically consists of 8-10 participants. Generally, participants are invited through self-identification processes based on their identities (e.g., cultural/race/ethnic, gender identity, sexual orientation, nationality, etc.) and their roles in the organization. The assessment team ensures that focus groups are informed by identity and role to facilitate environments that consider power and make participants feel comfortable to share sensitive or critical experiences and perspectives without fear of retaliation.

Focus groups are structured and facilitated using culturally responsive practices in order to create a safe space for members of the community to share openly and honestly. The research team forms affinity groups based on shared identities to mitigate power dynamics that can impair open sharing and create discomfort for marginalized populations and those in positions of lesser power. Affinity groups are defined as groups of people connected by common interest, purpose, position, or social identity. Recruitment efforts ensure that marginalized populations are represented with integrity and responsibility. Additionally, the responsive assessment module may recommend that research team members, especially focus group facilitators, share some lived experience with focus group participants to ensure cultural responsiveness and facilitate open, transparent communication.

The next phase of the process is the administration of a series of organization-wide surveys. Drawing from information gathered during the environmental scan, the research team develops research questions which are then used to develop survey questions. The survey questions are customized to each institution or client to align with the organizational culture and context and to ensure they are relevant and culturally responsive and address the relevant stakeholder groups. Key stakeholders and institutional leadership are encouraged to be actively engaged in the development of the survey questions and to review the survey before it is administered.

The enhanced survey module 124 may be designed to encourage respondents to provide information regarding their personal experiences at the institution and their perception of the institution's institutional policies and procedures regarding equity, diversity and inclusion. The enhanced survey module 124 design process is guided by a set of factors intended to strengthen usability. Some important areas of consideration for survey distribution include the timing of the enhanced survey module 124, getting representative samples of the target populations, ensuring timely response rates, and creating thoughtful and well-written questions that help tell the story of the organization with emphasis on strengths and opportunities for growth. The enhanced survey module 124 may identify the purpose, create methods for recruiting respondents, utilize high quality software, develop thoughtful data collection strategies, and include combinations of open-ended and closed-ended questions. The usability of the enhanced survey module 124 is measured by the effectiveness, efficiency, engagement, tolerance of errors, and ease of understanding questionnaire items. These practices and considerations ensure that the surveys will yield useful response rates that solicit rich, meaningful data to help transform the organization.

The questions associated with the enhanced survey module 124 are constructed based on the work of credible scholars and informed by instruments used in other institutional and organizational climate assessments. To make sure that the measures are reliable, the consultant team provides definitions for critical terms used in the enhanced survey module 124, confirms that questions are administered consistently, and verifies that the questions and response choices are worded such that they elicit consistent responses from participants. The questions are vetted by subject matter experts to establish that the measures of the equity assessment are valid and reliable: this ensures that they are contextually appropriate for the target population within the institution. The consultant team conducts a pilot test of the surveys to validate the survey questions and certify internal consistency.

To gain insights into the experiences and perceptions of organizational stakeholders, a mixed-methods approach may be utilized for the assessment. This approach included the use of focus group and survey data collection methods. Focus groups are conducted with stakeholders and other relevant community members to obtain qualitative data. Stakeholders may be recruited for participation in the focus group sessions using an electronically administered questionnaire. Focus group sessions were used to explore the perspectives on issues related to diversity, equity, and inclusion at an organization. Focus group findings were used to aid in the development of a quantitative survey that was also electronically administered to stakeholders.

The enhanced survey module 124 was developed using themes that emerged from the focus group sessions with stakeholders; environmental scan/document review; and a review of existing instruments. After the development of the enhanced survey module 124, it was reviewed by the institutional leadership to ensure applicability and context. An email containing an embedded link to the survey is sent by organizational leaders to key institutional stakeholders. To increase response and completion rates, participants have the option to skip questions and start and stop the survey at any time. All individuals are advised that their participation in the study was voluntary and that they can withdraw from the survey at any time.

To provide more detailed information about the sample, univariate, and bivariate analyses were conducted for each group and based on affinity groups (e.g., positions, racial/ethnic identity, sexual orientation, and disability status). Based on the relatively small number of responses for non-white individuals, those who identified as being a race other than white were grouped to create a people-of-color group. However, based on affinity, some groups (e.g., racial/ethnic, individuals with disability) were represented in the report despite the relatively small sample sizes. Valid percentages and number of responses (n) are presented throughout this report; in cases where the responses are less than 10 the frequency was removed to maintain anonymity. Responses of “prefer not to answer” are not included in sociodemographic tables. Some group size (i.e., n) may not add up to the total sample size due to missing data.

Quantitative and qualitative data from the entire assessment process are analyzed in accordance with best practices and presented by the consultant team in a way that is user-friendly. The report delineates the findings, trends, and patterns and includes data from the environmental scan, focus groups, and campus-wide survey, as well as recommendations based on the results of the assessment.

Members of the institution's community usually determine who has access to the final report. In some embodiments, the exemplary responsive assessment module may strongly encourage a high level of transparency and thus recommend that the report be made available to anyone who wishes to read it. This is not only in alignment with the whole concept and purpose of inclusivity but also acknowledges that issues and problems that are identified in the report can and should be solved by the community, as a community. This is only possible if everyone has access to the same information. Importantly, the safety of participants should always be considered when planning how the data are presented.

The final report is intended to share findings, trends, and patterns from the environmental scan, focus group sessions, and surveys. When possible, these findings are organized by social identity and thematic connections. The report should be written and presented in a manner that is inclusive, accessible, and easy for all members of the community to understand. This means that reading level and familiarity with statistical literacy should be considered (e.g., not all members of the community will be well-versed in statistics or statistical language). The findings should be presented in the most accessible way while still maintaining and communicating the key points. After the report is submitted, the consultant team coordinates a meeting with key stakeholders and leadership at the institution to discuss findings from the equity assessment. The meeting includes a discussion of potential opportunities for growth and institutional change identified from the data. This meeting should be structured in a way that allows time and space for feedback from the community.

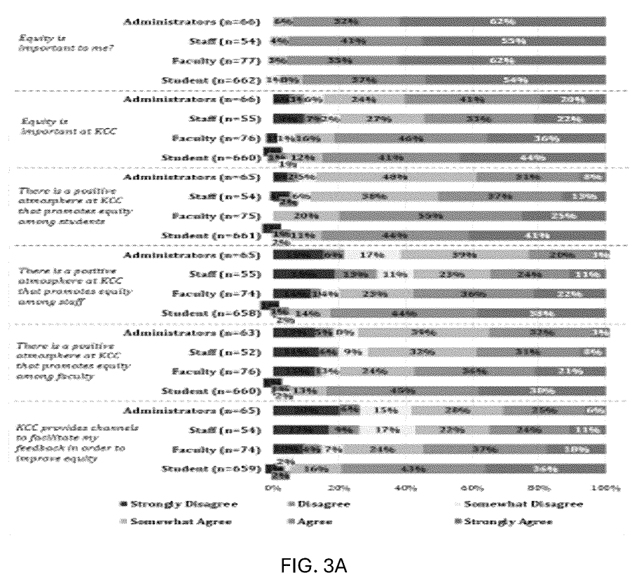

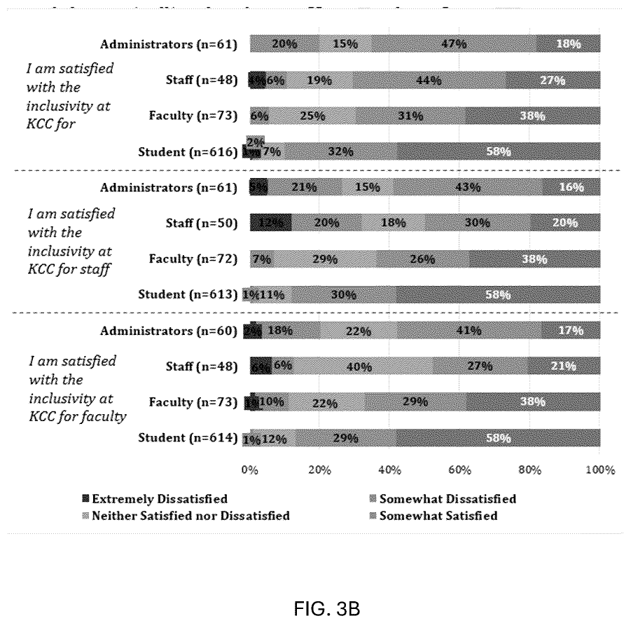

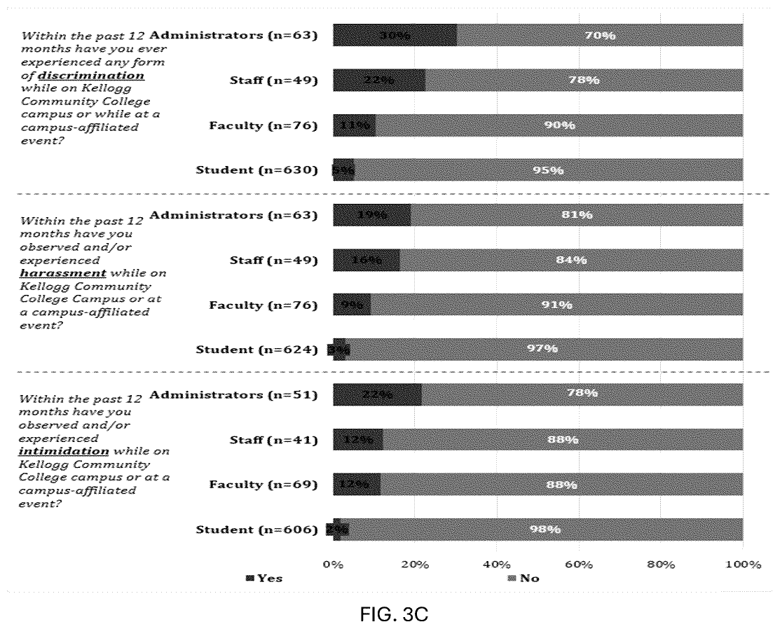

FIG. 3A-FIG. 3C depicts an output 302-306 of the exemplary survey module 124, in accordance with at least one embodiment of the present disclosure. In some embodiments, the exemplary survey module 124 may generate a plurality of reports that detail each assessment of the plurality of assessments associated with the responsive assessment module. FIG. 3A depicts an output 302 of the exemplary survey module 124 in response to particular assessment of equity within a predetermined location. In output 302, the particular assessment provides information for each parameter in the plurality of parameters to generate a particular recommendation based on the particular assessment. For example, equity is the particular parameter that is being determined in this particular assessment. In certain embodiments, the output 302 of the survey module 124 may refer to a generated notification associated with the exemplary responsive assessment module 118. In some embodiments, the output 302 may provide additional detail on the data associated with the plurality of researchers within the plurality of assessments. FIG. 3B depicts an output 304 of the exemplary survey module 124 in response to a particular assessment of inclusivity at the predetermined location. FIG. 3C depicts an output 306 of the exemplary survey module 124 in response to a plurality of assessments at the predetermined location. In some embodiments, the plurality of assessments may include an intimidation assessment, a harassment assessment, and a discrimination assessment between the plurality of researchers at the predetermined location. In certain embodiments, the output 306 of the survey module 124 may be correlated with a particular period of time, where the period of time allows for the assessment to remain relevant. In some embodiments, the exemplary responsive assessment module 118 may utilize the outputs 302-306 of the survey module 124 to optimize and update any subsequent assessments, as the outputs 302-306 may be historical input data to automatically train the responsive assessment module 118, as the responsive assessment module 118 may be a machine learning model and/or artificial intelligence model.

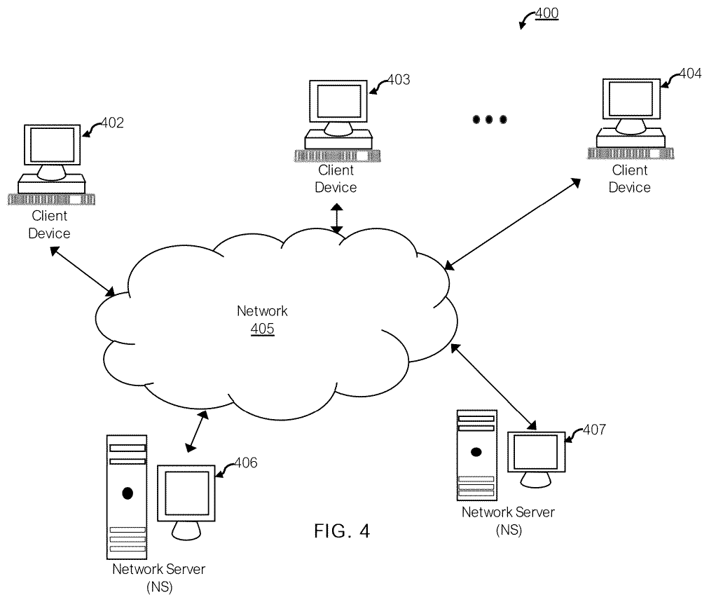

FIG. 4 depicts a block diagram of an exemplary computer-based system/platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform 400 may be configured to automatically modifying the interaction session to orchestrate a transfer of at least one artifact of the set of artifacts between the at least two entities, as detailed herein.

In some embodiments, the exemplary computer-based system/platform 400 may be based on a scalable computer and/or network architecture that incorporates varies strategies for assessing the data, caching, searching, and/or database connection pooling. An example of the scalable architecture is an architecture that is capable of operating multiple servers. In some embodiments, the exemplary inventive computing devices and/or the exemplary inventive computing components of the exemplary computer-based system/platform 400 may be configured to remotely execute the instructions associated with the exemplary responsive assessment module 118 of the present disclosure, automatically utilizing at least one machine-learning model described herein.

In some embodiments, referring to FIG. 4, members 402-404 (e.g., clients) of the exemplary computer-based system/platform 400 may include virtually any computing device capable of utilizing the exemplary responsive assessment module 118 to automatically execute the at least one recommendation via the enhanced survey module 124 via a network (e.g., cloud network 109), such as network 405, to and from another computing device, such as servers 406 and 407, each other, and the like. In some embodiments, the member devices 402-404 may be smart phones, personal computers, multiprocessor systems, microprocessor-based or programmable consumer electronics, network PCs, and the like. In some embodiments, one or more member devices within member devices 402-404 may include computing devices that connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 402-404 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 402-404 may include may launch one or more applications, such as Internet browsers, mobile applications, voice calls, video games, videoconferencing, and email, among others. In some embodiments, one or more member devices within member devices 402-404 may be configured to receive and to send web pages, and the like. In some embodiments, the exemplary responsive assessment module 118 may automatically execute the at least one recommendation via the enhanced survey module 124 and employ virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 402-404 may be specifically programmed by either Java, .Net, QT, C, C++ and/or other suitable programming language. In some embodiments, one or more member devices within member devices 402-404 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 405 may provide network access, data transport and/or other services to any computing device coupled to it. In some embodiments, the exemplary network 405 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 405 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 405 may include and implement, as an alternative or in conjunction with one or more of the above, a WiMAX architecture defined by the WiMAX forum. In some embodiments and, optionally, in combination of any embodiment described above or below, the exemplary network 405 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 405 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 405 may also include mass storage, such as network attached storage (NAS), a storage area network (SAN), a content delivery network (CDN) or other forms of computer or machine-readable media.

In some embodiments, the exemplary server 406 or the exemplary server 407 may be a web server (or a series of servers) running a network operating system, examples of which may include but are not limited to Microsoft Windows Server, Novell NetWare, or Linux. In some embodiments, the exemplary server 406 or the exemplary server 407 may be used for and/or provide cloud and/or network computing. Although not shown in FIG. 4, in some embodiments, the exemplary server 406 or the exemplary server 407 may have connections to external systems like email, SMS messaging, text messaging, ad content providers, etc. Any of the features of the exemplary server 406 may be also implemented in the exemplary server 407 and vice versa.

In some embodiments, one or more of the exemplary servers 406 and 407 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 401-404.

In some embodiments and, optionally, in combination of any embodiment described above or below, for example, one or more exemplary computing member devices 402-404, the exemplary server 406, and/or the exemplary server 407 may include a specifically programmed software module that may be configured to automatically execute the at least one recommendation via the enhanced survey module 124.

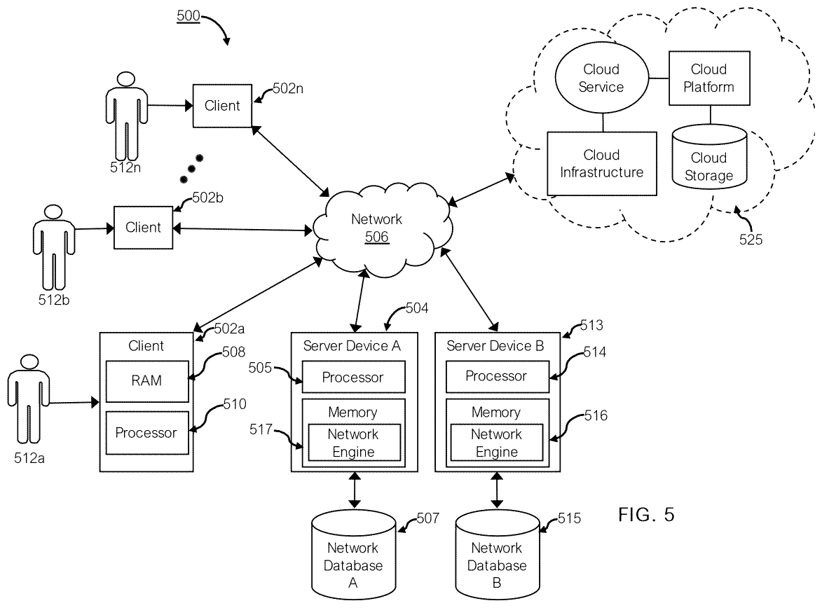

FIG. 5 depicts a block diagram of another exemplary computer-based system/platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 502a, 502b thru 502n shown each at least includes a computer-readable medium, such as a random-access memory (RAM) 508 coupled to a processor 510 or FLASH memory. In some embodiments, the processor 510 may execute computer-executable program instructions stored in memory 508. In some embodiments, the processor 510 may include a microprocessor, an ASIC, and/or a state machine. In some embodiments, the processor 510 may include, or may be in communication with, media, for example computer-readable media, which stores instructions that, when executed by the processor 510, may cause the processor 510 to perform one or more steps described herein. In some embodiments, examples of computer-readable media may include, but are not limited to, an electronic, optical, magnetic, or other storage or transmission device capable of providing a processor, such as the processor 510 of client 502a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 502a through 502n may also comprise a number of external or internal devices such as a mouse, a CD-ROM, DVD, a physical or virtual keyboard, a display, a speaker, or other input or output devices. In some embodiments, examples of member computing devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices. In some embodiments, member computing devices 502a through 502n may be specifically programmed with one or more application programs in accordance with one or more principles/methodologies detailed herein. In some embodiments, member computing devices 502a through 502n may operate on any operating system capable of supporting a browser or browser-enabled application, such as Microsoft™, Windows™, and/or Linux. In some embodiments, member computing devices 502a through 502n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 502a through 502n, users, 512a through 512n, may communicate over the exemplary network 506 with each other and/or with other systems and/or devices coupled to the network 506. As shown in FIG. 5, exemplary server devices 504 and 513 may be also coupled to the network 506. Exemplary server device 504 may include a processor 505 coupled to a memory that stores a network engine 517. Exemplary server device 513 may include a processor 514 coupled to a memory 516 that stores a network engine. In some embodiments, one or more member computing devices 502a through 502n may be mobile clients. As shown in FIG. 5, the network 506 may be coupled to a cloud computing/architecture(s) 525. The cloud computing/architecture(s) 525 may include a cloud service coupled to a cloud infrastructure and a cloud platform, where the cloud platform may be coupled to a cloud storage.

In some embodiments, at least one database of exemplary databases 507 and 515 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

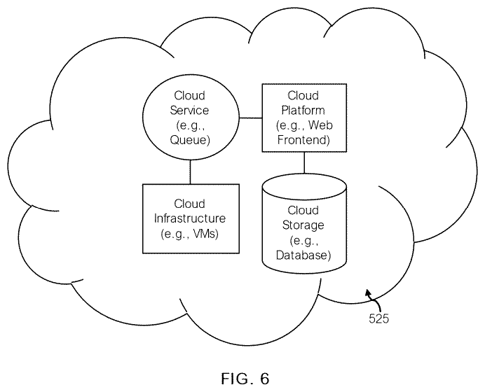

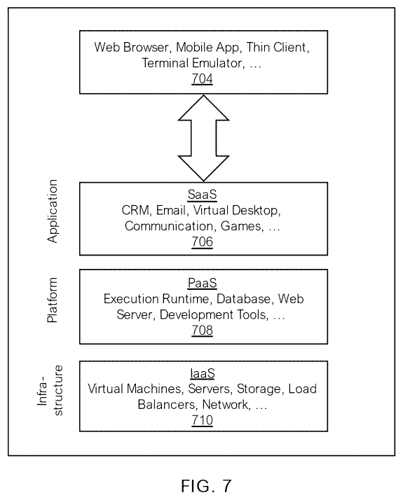

FIG. 6 and FIG. 7 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate. FIG. 6 illustrates an expanded view of the cloud computing/architecture(s) 525 found in FIG. 5. FIG. 7, illustrates the exemplary inventive computer-based components of the present disclosure may be specifically configured to operate in the cloud computing/architecture 525 as a source database 704, where the source database 704 may be a web browser, a mobile application, a thin client, and a terminal emulator. In FIG. 7, the exemplary inventive computer-based systems/platforms, the exemplary inventive computer-based devices, and/or the exemplary inventive computer-based components of the present disclosure may be specifically configured to operate in a cloud computing/architecture such as, but not limiting to: infrastructure a service (IaaS) 710, platform as a service (PaaS) 708, and/or software as a service (SaaS) 706.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; knowledge corpus; stored audio recordings; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. In some embodiments, the server may store transactions and dynamically trained machine learning models. Cloud servers are examples.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a social media post, a map, an entire application (e.g., a calculator), etc. In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD™, NetBSD™, OpenBSD™; (2) Linux™; (3) Microsoft Windows™; (4) OS X (MacOS)™; (5) MacOS 11™; (6) Solaris™; (7) Android™; (8) iOS™; (9) Embedded Linux™; (10) Tizen™; (11) WebOS™; (12) IBM i™; (13) IBM AIX™; (14) Binary Runtime Environment for Wireless (BREW)™; (15) Cocoa (API)™; (16) Cocoa Touch™; (17) Java Platforms™; (18) JavaFX™; (19) JavaFX Mobile; TM (20) Microsoft DirectX™; (21).NET Framework™; (22) Silverlight™; (23) Open Web Platform™; (24) Oracle Database™; (25) Qt™; (26) Eclipse Rich Client Platform™; (27) SAP NetWeaver™; (28) Smartface™; and/or (29) Windows Runtime™.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device. In at least one embodiment, the exemplary responsive assessment module 118 of the present disclosure, utilizing at least one machine-learning model described herein, may be referred to as exemplary software.

In some embodiments, exemplary inventive computer-based systems/platforms, exemplary inventive computer-based devices, and/or exemplary inventive computer-based components of the present disclosure may be configured to handle numerous concurrent tests for software agents that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

What is claimed is:

1. A computer-implemented method comprising:
identifying, by a processor, a plurality of data types associated with input data;
determining, by the processor, a plurality of parameters corresponding to each data type of the plurality of data types;
analyzing, by the processor, the plurality of parameters utilizing an enhanced survey module, wherein the analysis comprises a combination of qualitative data analysis and quantitative data analysis;
dynamically generating, by the processor, a notification based on the analysis, the notification comprising at least one recommendation for subsequent action based on the analysis; and
automatically executing, by the processor, the at least one recommendation via the enhanced survey module.

2. The method of claim 1, wherein the plurality of parameters comprises outputs of calculated predictions corresponding to each data type of the input data.

3. The method of claim 1, wherein the enhanced survey module further comprises a natural language processing module configured to analyze the plurality of parameters.

4. The method of claim 1, wherein the dynamically generated notification further comprises a recommendation for subsequent action based on comparing the plurality of parameters to predetermined thresholds.

5. The method of claim 1, wherein the input data comprises historical data associated with outputs of action-specific focus group discussions.

6. The method of claim 1, wherein automatically executing the at least one recommendation further comprises invoking an executable action to optimize system performance based on the analysis.

7. The method of claim 1, wherein analyzing the plurality of parameters further comprises normalizing the plurality of parameters to account for variances in the input data.

8. The method of claim 1, further comprising calibrating the enhanced survey module using a trained machine learning algorithm on the plurality of parameters prior to dynamically generating the notification.

9. The method of claim 1, wherein the dynamically generated notification is formatted to include assessments of equity, diversity, and inclusion metrics derived from the analysis.

10. A computer-implemented method comprising:
identifying, by a processor, a plurality of data types associated with input data;
determining, by the processor, a plurality of parameters corresponding to each data type of the plurality of data types;
analyzing, by the processor, the plurality of parameters utilizing an enhanced survey module, wherein the analysis comprises a combination of qualitative data analysis and quantitative data analysis;
calibrating, by the processor, the enhanced survey module via a trained machine learning module to generate a notification associated with the analysis of the plurality of parameters;
dynamically updating, by the processor, the notification based on an output of the calibration of the enhanced survey module and the analysis, the notification comprising at least one recommendation for subsequent action based on the analysis; and
automatically executing, by the processor, the at least one recommendation via the enhanced survey module.

11. The method of claim 10, wherein the plurality of parameters comprises outputs of calculated predictions corresponding to each data type of the input data.

12. The method of claim 10, wherein the enhanced survey module further comprises a natural language processing module configured to analyze the plurality of parameters.

13. The method of claim 10, wherein the dynamically generated notification further comprises a recommendation for subsequent action based on comparing the plurality of parameters to predetermined thresholds.

14. The method of claim 10, wherein the input data comprises historical data associated with outputs of action-specific focus group discussions.

15. The method of claim 10, wherein automatically executing the at least one recommendation further comprises invoking an executable action to optimize system performance based on the analysis.

16. The method of claim 10, wherein analyzing the plurality of parameters further comprises normalizing the plurality of parameters to account for variances in the input data.

17. The method of claim 10, wherein the dynamically generated notification is formatted to include assessments of equity, diversity, and inclusion metrics derived from the analysis.

18. A system comprising:
a non-transient computer memory, storing software instructions;
at least one or more components of at least one processor configured to execute the software instructions that cause the at least one processor to perform steps to:
identify a plurality of data types associated with input data;
determine a plurality of parameters corresponding to each data type of the plurality of data types;
analyze the plurality of parameters utilizing an enhanced survey module, wherein the analysis comprises a combination of qualitative data analysis and quantitative data analysis;
dynamically generate a notification based on the analysis, the notification comprising at least one recommendation for subsequent action based on the analysis; and
automatically execute the at least one recommendation via the enhanced survey module.

19. The system of claim 18, wherein the enhanced survey module further comprises a natural language processing module configured to analyze the plurality of parameters.

20. The system of claim 18, wherein the software instructions further comprise calibrating the enhanced survey module using a trained machine learning algorithm on the plurality of parameters prior to dynamically generating the notification.
